(19) United States
(12) Patent Application Publication
(10) Pub. No.: US 2025/0310749 A1
(43) Pub. Date: Oct. 2, 2025

(54) Retrieving Buffered Downlink Data Across a Roaming Transition

(71) Applicant: Apple Inc., Cupertino, CA (US)

(72) Inventors: Pooya Monajemi, Sunnyvale, CA (US); Chittabrata Ghosh, Fremont, CA (US); Zhou Lan, San Jose, CA (US); Jarkko L. Kneckt, Los Gatos, CA (US); Morteza Mehrnoush, Emerald Hills, CA (US); Anuj Batra, Redwood City, CA (US); Yong Liu, Campbell, CA (US)

(21) Appl. No.: 19/082,453

(22) Filed: Mar. 18, 2025

Related U.S. Application Data
(60) Provisional application No. 63/572,033, filed on Mar. 29, 2024.

(51) Int. Cl. H04W 8/08; H04L 5/00; H04W 84/12

(52) U.S. Cl. CPC H04W 8/08; H04L 5/0055; H04W 84/12

(57) ABSTRACT

This disclosure relates to methods for retrieving buffered downlink data from an origin access point while roaming in a wireless local area network system. A non-access point wireless device can initiate from a first access point to a second access point. The non-access point wireless device can receive an indication that roaming from the first access point to the second access point is ready. The non-access point wireless device can receive downlink data from both the first access point and the second access point after the roaming from the first access point to the second access point is ready.

### PRIORITY INFORMATION

This application claims priority to U.S. provisional patent application Ser. No. 63/572,033, entitled “Retrieving Buffered Downlink Data Across a Roaming Transition,” filed Mar. 29, 2024, which is hereby incorporated by reference in its entirety as though fully and completely set forth herein.

### TECHNICAL FIELD

The present application relates to wireless communication, including techniques and devices for retrieving buffered downlink data across a roaming transition in a wireless local area network architecture.

### DESCRIPTION OF THE RELATED ART

Wireless communication systems are ubiquitous. Further, wireless communication technology has evolved from voice-only communications to also include the transmission of data, such as Internet and multimedia content.

Mobile electronic devices, or stations (STAs) or user equipment devices (UEs), can take the form of smart phones or tablets that a user typically carries. One aspect of wireless communication that can commonly be performed by mobile devices can include wireless networking, for example over a wireless local area network (WLAN), which can include devices that operate according to one or more communication standards in the IEEE 802.11 family of standards. Providing strong support for mobility, potentially including for roaming between access points in a WLAN setting, can provide significant benefits for mobile devices, but can also come with additional design challenges. Accordingly, improvements in the field are desired.

### SUMMARY

Embodiments are presented herein of, inter alia, systems, apparatuses, and methods for devices to retrieve buffered downlink data across a roaming transition in a wireless local area network architecture.

A wireless device can include one or more antennas, one or more radios operably coupled to the one or more antennas, and a processor operably coupled to the one or more radios. The wireless device can be configured to establish a connection with an access point through a wireless local area network (WLAN) over one or multiple wireless links, or can be an access point configured to establish a connection with one or more other wireless devices through a WLAN over one or multiple wireless links. The wireless device can operate in each of the multiple wireless links using a respective radio of the one or more radios.

Multiple approaches are described herein for retrieving downlink data that is buffered at an original access point for a wireless device after roaming to a target access point. The approaches can have varying levels of implementation complexity as well as throughput and latency characteristics.

The approaches include a fully sequential approach, in which all downlink data that is buffered at the original access point is retrieved before the wireless device begins retrieving downlink data from the target access point, as well as a sequential-per-traffic identifier approach, in which all downlink data that is buffered at the original access point for a given traffic identifier is retrieved before the wireless device begins retrieving downlink data for that traffic identifier from the target access point. In this sequential-per-traffic identifier approach, it can be possible that traffic (e.g., of different traffic identifiers) can be concurrently retrieved from both the original access point and the target access point. Another approach described herein includes a fully concurrent downlink approach, in which separate block acknowledgement sessions and/or sequence and packet number synchronization techniques are used to enable both the original access point and the target access point to concurrently provide downlink data to the wireless device across the roaming transition. An approach in which buffered downlink data from the original access point can be transferred to the target access point for retrieval by the wireless device is also described herein.

The techniques described herein can be implemented in and/or used with a number of different types of devices, including but not limited to cellular phones, tablet computers, accessory and/or wearable computing devices, portable media players, base stations, access points, and other network infrastructure equipment, servers, unmanned aerial vehicles, unmanned aerial controllers, automobiles and/or motorized vehicles, and any of various other computing devices.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example wireless communication system including a wireless device, according to some embodiments;

FIG. 2 is a block diagram illustrating an example wireless device, according to some embodiments;

FIG. 3 is a block diagram illustrating an example network element or access point, according to some embodiments;

FIG. 4 is a block diagram illustrating an example modem or baseband processor, according to some embodiments;

FIG. 5 is a flowchart diagram illustrating an example method for retrieving buffered downlink data across a roaming transition in a wireless local area network, according to some embodiments;

FIG. 6 is a signal flow diagram illustrating example aspects of a possible scenario in which downlink data is available from multiple access point devices while roaming in a wireless local area network setting, according to some embodiments;

FIGS. 7-10 are signal flow diagrams illustrating example aspects of various possible approaches to handling scenarios in which downlink data is available from multiple access point devices while roaming in a wireless local area network setting, according to some embodiments;

FIGS. 11-13 illustrate additional example aspects of the approaches of FIGS. 7-9, according to some embodiments;

FIG. 14 is a table illustrating a possible feature comparison between the approaches of FIGS. 7-9, according to some embodiments;

FIG. 15 is a signal flow diagram illustrating further possible details of a concurrent downlink approach to handling scenarios in which downlink data is available from multiple access point devices while roaming in a wireless local area network setting, according to some embodiments; and

FIGS. 16-18 illustrate example aspects of various possible outcomes for the sequence number and packet number space during roaming using a concurrent downlink approach to handling scenarios in which downlink data is available from multiple access point devices while roaming in a wireless local area network setting, according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terminology

The following are definitions of terms used in this disclosure:

Memory Medium—Any of various types of non-transitory memory devices or storage devices. The term “memory medium” is intended to include any computer system memory or random access memory, such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The term “memory medium” can include two or more memory mediums which can reside in different locations, e.g., in different computer systems that are connected over a network. The memory medium can store program instructions (e.g., embodied as computer programs) that can be executed by one or more processors.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), server-based computer system, wearable computer, network appliance, Internet appliance, smartphone, television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems or devices that are mobile or portable, and that perform wireless communications. Examples of UE devices include mobile telephones or smart phones (e.g., iPhone™, Android™-based phones), tablet computers, portable gaming devices, laptops, wearable devices (e.g., smart watch, smart glasses, smart goggles, head-mounted display devices, and so forth), portable Internet devices, music players, data storage devices, or other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device or Station (STA)—any of various types of computer systems or devices that perform wireless communications. A wireless device can be portable (or mobile), or can be stationary or fixed at a certain location. The terms “station” and “STA” are used similarly. A UE is an example of a wireless device.

Communication Device—any of various types of computer systems or devices that perform communications, where the communications can be wired or wireless. A communication device can be portable (or mobile) or can be stationary or fixed at a certain location. A wireless device is an example of a communication device. A UE is another example of a communication device.

Base Station or Access Point (AP)—The term “Base Station” has the full breadth of its ordinary meaning, and at least includes a wireless communication station installed at a fixed location and used to communicate as part of a wireless communication system. The term “access point” (or “AP”) is typically associated with Wi-Fi-based communications and is used similarly.

Processing Element (or Processor)—refers to various elements or combinations of elements that are capable of performing a function in a device, e.g., in a communication device or in a network infrastructure device. Processors can include, for example: processors and associated memory, circuits such as an ASIC (Application Specific Integrated Circuit), portions or circuits of individual processor cores, entire processor cores, processor arrays, programmable hardware devices such as a field programmable gate array (FPGA), and/or larger portions of systems that include multiple processors, as well any of various combinations of the above.

IEEE 802.11—refers to technology based on IEEE 802.11 wireless standards such as 802.11a, 802.11b, 802.11g, 802.11n, 802.11-2012, 802.11ac, 802.11ad, 802.11ax, 802.11ay, 802.11be, and/or other IEEE 802.11 standards. IEEE 802.11 technology can also be referred to as “Wi-Fi” or “wireless local area network (WLAN)” technology.

Configured to-Various components can be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors can be configured to electrically connect a module to another module, even when the two modules are not connected). In some contexts, “configured to” can be a broad recitation of structure generally meaning “having circuitry that” performs the task or tasks during operation. As such, the component can be configured to perform the task even when the component is not currently on. In general, the circuitry that forms the structure corresponding to “configured to” can include hardware circuits.

Various components can be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

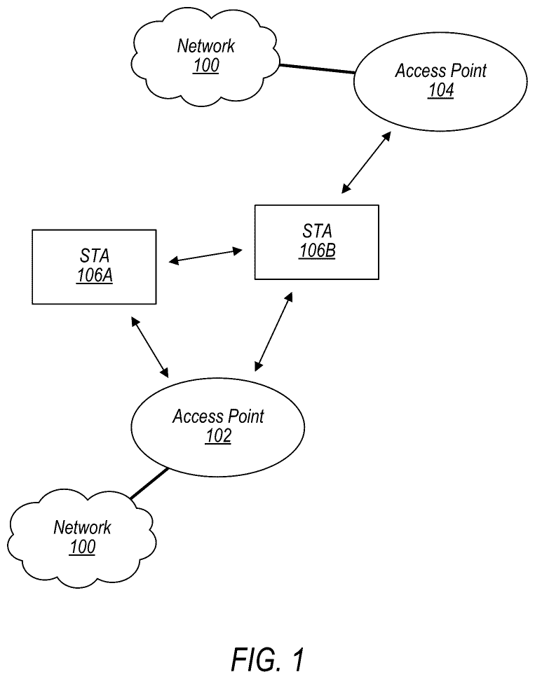

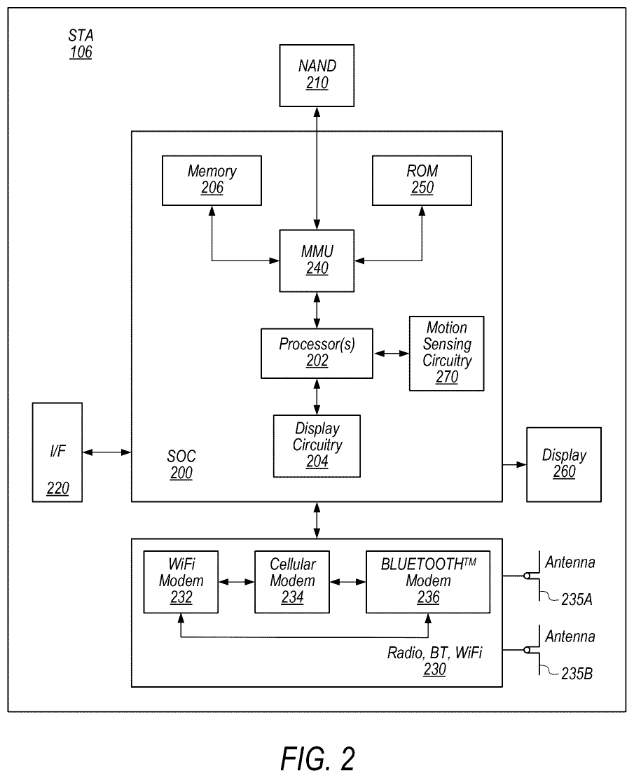

### FIGS. 1-2—Wireless Communication System

FIG. 1 illustrates an example of a wireless communication system. It is noted that FIG. 1 represents one possibility among many, and that features of the present disclosure can be implemented in any of various systems, as desired. For example, instances described herein can be implemented in any type of wireless device. The wireless communication system described below is one example.

As shown, the exemplary wireless communication system includes an access point (AP) 102, which communicates over a transmission medium with one or more wireless devices 106A, 106B, etc. Wireless devices 106A and 106B can be user devices, such as stations (STAs), non-AP STAs, UEs, or WLAN devices.

The STA 106 can be a device with wireless network connectivity such as a mobile phone, a hand-held device, a wearable device (e.g., such as a smart watch, smart glasses, and/or a head-mounted display device), a computer or a tablet, an unmanned aerial vehicle (UAV), an unmanned aerial controller (UAC), an automobile, or virtually any type of wireless device. The STA 106 can include a processor (processing element) that is configured to execute program instructions stored in memory. The STA 106 can perform any of the methods described herein by executing such stored instructions. Alternatively, or in addition, the STA 106 can include a programmable hardware element such as an FPGA (field-programmable gate array), an integrated circuit, and/or any of various other possible hardware components that are configured to perform (e.g., individually or in combination) any of the methods described herein, or any portion of any of the methods described herein.

The AP 102 can be a stand-alone AP or an enterprise AP, can be a base transceiver station (BTS) or cell site, and can include hardware that enables wireless communication with the STA devices 106A and 106B. The AP 102 can also be equipped to communicate with a network 100 (e.g., a core network of a service provider (e.g., a cellular service provider, an Internet service provider, and/or a carrier), a WLAN, an enterprise network, and/or another communication network connected to the Internet, among various possibilities). Thus, the AP 102 can facilitate communication among the STA devices 106 and/or between the STA devices 106 and the network 100. AP 102 can be configured to provide communications over one or more wireless technologies, such as any, any combination of, and/or all of 802.11 a, b, g, n, ac, ad, ax, ay, be and/or other 802.11 versions, and/or a cellular protocol, such as 6G, 5G and/or LTE, including in an unlicensed band.

The communication area (or coverage area) of the AP 102 can be referred to as a basic service area (BSA) or cell. The AP 102 and the STAs 106 can be configured to communicate over the transmission medium using any of various radio access technologies (RATs) or wireless communication technologies, such as Wi-Fi, LTE, LTE-Advanced (LTE-A), 5G NR, 6G, ultra-wideband (UWB), etc.

AP 102 and other similar access points (not shown) operating according to one or more wireless communication technologies can thus be provided as a network, which can provide continuous or nearly continuous overlapping service to STA devices 106A-B and similar devices over a geographic area, e.g., via one or more communication technologies. A STA can roam from one AP to another AP directly, or can transition between APs and/or network cells (e.g., such as cellular network cells).

Note that at least in some instances a STA device 106 can be capable of communicating using any of multiple wireless communication technologies. For example, a STA device 106 might be configured to communicate using Wi-Fi, LTE, LTE-A, 5G NR, 6G, Bluetooth, UWB, one or more satellite systems, etc. Other combinations of wireless communication technologies (including more than two wireless communication technologies) are also possible. Likewise, in some instances a STA device 106 can be configured to communicate using only a single wireless communication technology.

As shown, the exemplary wireless communication system can also include an access point (AP) 104, which communicates over a transmission medium with the wireless device 106B. The AP 104 also provides communicative connectivity to the network 100. Thus, wireless devices can connect to either or both of AP 102 (or another cellular base station) and the access point 104 (or another access point) to access the network 100. For example, a STA can roam from AP 102 to AP 104 based on one or more factors, such as coverage, interference, and capabilities. Note that it can also be possible for the AP 104 to provide access to a different network (e.g., an enterprise Wi-Fi network, a home Wi-Fi network, etc.) than the network to which the AP 102 provides access.

The STAs 106A and 106B can include handheld devices such as smart phones or tablets, wearable devices such as smart watches, smart glasses, head-mountable display devices, and/or can include any of various types of devices with wireless communication capability. For example, one or more of the STAs 106A and/or 106B can be a wireless device intended for stationary or nomadic deployment such as an appliance, measurement device, control device, etc.

The STA 106B can also be configured to communicate with the STA 106A. For example, the STA 106A and STA 106B can be capable of performing direct device-to-device (D2D) communication. Note that such direct communication between STAs can also or alternatively be referred to as peer-to-peer (P2P) communication. The direct communication can be supported by the AP 102 (e.g., the AP 102 can facilitate discovery, among various possible forms of assistance), or can be performed in a manner unsupported by the AP 102. Such P2P communication can be performed using 3GPP-based D2D communication techniques, Wi-Fi-based P2P communication techniques, UWB, BT, and/or any of various other direct communication techniques, according to various examples.

The STA 106 can include one or more devices or integrated circuits for facilitating wireless communication, potentially including a Wi-Fi modem, cellular modem, and/or one or more other wireless modems. The wireless modem(s) can include one or more processors (processor elements) and various hardware components as described herein. The STA 106 can perform any of (or any portion of) the methods described herein by executing instructions on one or more programmable processors. For example, the STA 106 can be configured to perform techniques for retrieving buffered downlink data across a roaming transition in a wireless communication system, such as according to the various methods described herein. Alternatively, or in addition, the one or more processors can be one or more programmable hardware elements such as an FPGA (field-programmable gate array), application-specific integrated circuit (ASIC), or other circuitry, that is configured to perform any of the methods described herein, or any portion of any of the methods described herein. The wireless modem(s) described herein can be used in a STA device as defined herein, a wireless device as defined herein, or a communication device as defined herein. The wireless modem described herein can also be used in an AP, a base station, a pico cell, a femto cell, and/or other similar network side device.

The STA 106 can include one or more antennas for communicating using two or more wireless communication protocols or radio access technologies. In some instances, the STA device 106 can be configured to communicate using a single shared radio. The shared radio can couple to a single antenna, or can couple to multiple antennas (e.g., for MIMO) for performing wireless communications. Alternatively, the STA device 106 can include two or more radios, each of which can be configured to communicate via a respective wireless link. Other configurations are also possible.

### FIG. 2—Example Block Diagram of a STA Device

FIG. 2 illustrates an example block diagram of a STA device, such as STA 106. In some instances, the STA 106 can additionally or alternatively be referred to as a UE 106. STA 106 also can be referred to as a non-AP STA 106. As shown, the STA 106 can include a system on chip (SOC) 200, which can include one or more portions configured for various purposes. Some or all of the various illustrated components (and/or other device components not illustrated, e.g., in variations and alternative arrangements) can be “communicatively coupled” or “operatively coupled,” which terms can be taken herein to mean components that can communicate, directly or indirectly, when the device is in operation.

In some instances, the STA 106 can be configured as a Multi-Link Device (MLD). In such instances, the STA 106 (e.g., one or more radios of the STA 106) can be configured for concurrent data transmission and reception in multiple channels across a single band and/or multiple frequency bands (e.g., such as a 2.4 GHz band, a 5 GHz band, and/or a 6 GHz band). As such, the STA 106 (e.g., one or more radios of the STA 106) can be configured to perform Multi-Link Operation (MLO). For example, the STA 106 (e.g., one or more radios of the STA 106) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

As shown, the SOC 200 can include processor(s) 202 which can execute program instructions for the STA 106, and display circuitry 204 which can perform graphics processing and provide display signals to the display 260. The SOC 200 can also include motion sensing circuitry 270 which can detect motion of the STA 106, for example using a gyroscope, accelerometer, and/or any of various other motion sensing components. The processor(s) 202 can also be coupled to memory management unit (MMU) 240, which can be configured to receive addresses from the processor(s) 202 and translate those addresses to locations in memory (e.g., memory 206, read only memory (ROM) 250, flash memory 210). The MMU 240 can be configured to perform memory protection and page table translation or set up. In some instances, the MMU 240 can be included as a portion of the processor(s) 202.

As shown, the SOC 200 can be coupled to various other circuits of the STA 106. For example, the STA 106 can include various types of memory (e.g., including NAND flash 210), a connector interface 220 (e.g., for coupling to a computer system, dock, charging station, etc.), the display 260, and wireless communication circuitry 230 (e.g., for LTE, LTE-A, 5G NR, 6G, Bluetooth, Wi-Fi, NFC, GPS, UWB, peer-to-peer (P2P), device-to-device (D2D), etc.).

The STA 106 can include at least one antenna, and in some instances multiple antennas 235A and 235B, for performing wireless communication with access points, base stations, wireless stations, and/or other devices. For example, the STA 106 can use antennas 235A and 235B to perform the wireless communication. As noted above, the STA 106 can, in some examples, be configured to communicate wirelessly using a plurality of wireless communication standards or radio access technologies (RATs).

The wireless communication circuitry 230 can include a Wi-Fi modem 232, a cellular modem 234, and a Bluetooth modem 236. Note that one or more of the Wi-Fi modem 232, the cellular modem 234, and/or the Bluetooth modem 236 can be configured for MLO, e.g., as described above. The Wi-Fi modem 232 is for enabling the STA 106 to perform Wi-Fi or other WLAN communications, e.g., on an 802.11 network. The Bluetooth modem 236 is for enabling the STA 106 to perform Bluetooth communications. The cellular modem 234 can be a cellular modem capable of performing cellular communication according to one or more cellular communication technologies, e.g., in accordance with one or more 3GPP specifications.

As described herein, STA 106 can include hardware and software components for implementing aspects of this disclosure. For example, one or more components of the wireless communication circuitry 230 (e.g., Wi-Fi modem 232, cellular modem 234, BT modem 236) of the STA 106 can be configured to implement part or all of the methods for retrieving buffered downlink data across a roaming transition described herein, e.g., by a processor executing program instructions stored on a memory medium (e.g., a non-transitory computer-readable memory medium), a processor configured as an FPGA (Field Programmable Gate Array), and/or using dedicated hardware components, which can include an ASIC (Application Specific Integrated Circuit).

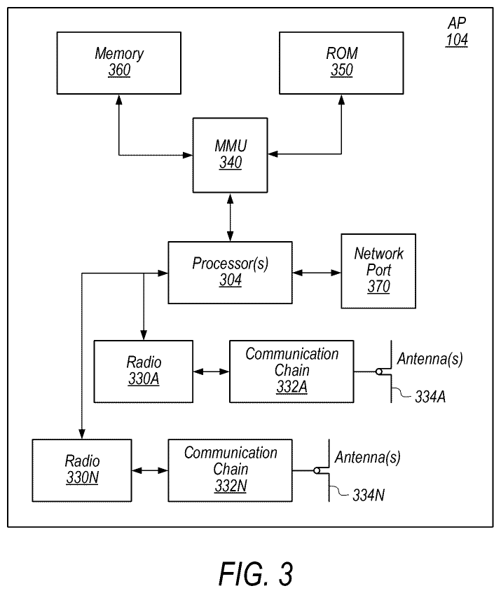

### FIG. 3—Block Diagram of an Access Point

FIG. 3 illustrates an example block diagram of an access point (AP) 104. In some instances (e.g., in an 802.11 communication context), the AP 104 can also be referred to as a station (STA), and possibly more particularly as an AP STA. It is noted that the AP of FIG. 3 is merely one example of a possible access point. As shown, AP 104 can include processor(s) 304, which can execute program instructions for the AP 104. The processor(s) 304 can also be coupled to memory management unit (MMU) 340, which can be configured to receive addresses from the processor(s) 304 and translate those addresses to locations in memory (e.g., memory 360 and read only memory (ROM) 350) or to other circuits or devices.

In some instances, the AP 104 can be configured as a Multi-Link Device (MLD). In such instances, the AP 104 (e.g., one or more radios of the AP 104) can be configured for concurrent data transmission and reception in multiple channels across a single band and/or multiple frequency bands (e.g., such as a 2.4 GHz band, a 5 GHz band, and/or a 6 GHz band). As such, the AP 104 (e.g., one or more radios of the AP 104) can be configured to perform Multi-Link Operation (MLO). For example, the AP 104 (e.g., one or more radios of the AP 104) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The AP 104 can include at least one network port 370. The network port 370 can be configured to couple to a network and provide multiple devices, such as STA devices 106, with access to the network, for example as described herein above in FIG. 1.

The network port 370 (or an additional network port) can also or alternatively be configured to couple to a cellular network, e.g., a core network of a cellular service provider (e.g., a carrier and/or cellular carrier). The core network can provide mobility related services and/or other services to a plurality of devices, such as STA devices 106. In some cases, the network port 370 can couple to a telephone network via the core network, and/or the core network can provide a telephone network (e.g., among other STA devices serviced by the cellular service provider).

The AP 104 can include one or more radios 330A-330N, each of which can be coupled to a respective communication chain and at least one antenna 334, and possibly multiple antennas. The antenna(s) 334 can be configured to operate as a wireless transceiver and can be further configured to communicate with STA devices 106 via radios 330A-330N. Note that one or more of the radios 330A-330N can be configured for MLO, e.g., as described above. The antenna(s) 334A-N communicate with their respective radios 330A-N via communication chains 332A-N. Communication chains 332 can be receive chains, transmit chains, or both. The radios 330A-N can be configured to communicate in accordance with various wireless communication standards, including, but not limited to, LTE, LTE-A, 5G NR, 6G, UWB, Wi-Fi, BT, etc. The AP 104 can be configured to operate on multiple wireless links using the one or more radios 330A-N, wherein each radio is used to operate on a respective wireless link.

The AP 104 can be configured to communicate wirelessly using multiple wireless communication standards. In some instances, the AP 104 can include multiple radios, which can enable the network entity to communicate according to multiple wireless communication technologies. For example, as one possibility, the AP 104 can include a 4G or 5G radio for performing communication according to a 3GPP wireless communication technology as well as a Wi-Fi radio for performing communication according to Wi-Fi. In such a case, the AP 104 can be capable of operating as both a cellular base station and a Wi-Fi access point. As another possibility, the AP 104 can include a multi-mode radio, which is capable of performing communications according to any of multiple wireless communication technologies (e.g., 5G NR and Wi-Fi, 5G NR and LTE, etc.). As still another possibility, the AP 104 can be configured to act exclusively as a Wi-Fi access point, e.g., without cellular communication capability.

As described further herein, the AP 104 can include hardware and software components for implementing or supporting implementation of features described herein, such as supporting a wireless device to perform retrieving buffered downlink data across a roaming transition, among various other possible features. The processor 304 of the AP 104 can be configured to implement, or support implementation of, part or all of the methods described herein, e.g., by executing program instructions stored on a memory medium (e.g., a non-transitory computer-readable memory medium) to operate multiple wireless links using multiple respective radios. Alternatively, the processor 304 can be configured as a programmable hardware element, such as an FPGA (Field Programmable Gate Array) or ASIC (Application Specific Integrated Circuit), or a combination thereof. Alternatively (or in addition) the processor 304 of the AP 104, in conjunction with one or more of the other components 330, 332, 334, 340, 350, 360, 370 can be configured to implement, or support implementation of, part or all of the features described herein.

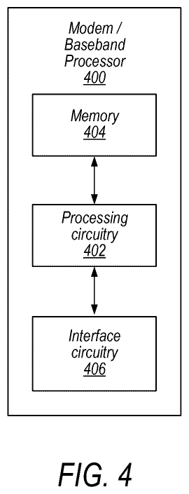

### FIG. 4—Block Diagram of a Modem or Baseband Processor

FIG. 4 illustrates an example block diagram of a modem 400, which can also be referred to as baseband processor 400. The modem 400 can provide signal processing functionality for one or more wireless communication technologies, such as Wi-Fi, Bluetooth, and/or a cellular (e.g., 3GPP) communication technology. Thus, as one possibility, modem 400 can represent a Wi-Fi modem; for example, the modem 400 illustrated in FIG. 4 can represent one possible example of Wi-Fi modem 232 illustrated in FIG. 2. As another possibility, modem 400 can represent a cellular modem or cellular baseband processor; for example, the modem 400 illustrated in FIG. 4 can represent one possible example of cellular modem 234 illustrated in FIG. 2. As a still further possibility, modem 400 can represent a Bluetooth modem; for example, the modem 400 illustrated in FIG. 4 can represent one possible example of Wi-Fi modem 236 illustrated in FIG. 2. In some instances, the modem 400 could implement functionality for supporting communication according to multiple wireless communication technologies. At least in some instances, the modem 400 can run a real-time operating system, e.g., for facilitating performance of timing-dependent wireless communication functionality.

In some instances, the modem 400 can be configured for concurrent data transmission and reception in multiple channels across a single band and/or multiple frequency bands (e.g., such as a 2.4 GHz band, a 5 GHz band, and/or a 6 GHz band). As such, the modem 400 can be configured to perform Multi-Link Operation (MLO). For example, the modem 400 can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The modem 400 can include processing circuitry 402, which could include one or more processor cores, ASICs, programmable hardware elements, digital signal processors, and/or other processing elements. The processing circuitry can be capable of preparing baseband signals for up-conversion and transmission by radio circuitry of a wireless device, and/or for processing baseband signals received and down-converted by radio circuitry of a wireless device. Such processing could include signal modulation, encoding, decoding, etc., among various possible functions. The processing circuitry can also or alternatively be capable of performing functionality for one or more baseband and/or other layers/sublayers of a protocol stack for the wireless communication technology (or technologies) implemented by the modem 400, such as physical layer (PHY) functionality, media access control (MAC) functionality, logical link control (LLC) functionality, radio resource control (RRC) functionality, radio link control (RLC) functionality, etc. In some instances, the modem 400 can itself include at least some radio circuitry (e.g., for performing the conversion of input baseband signals to radio frequency signals and/or of input radio frequency signals to baseband signals). Alternatively, or in addition, some or all such functions can be performed by separate radio/transceiver components of the wireless device.

The modem 400 can also include memory 404, which can include a non-transitory computer-readable memory medium. The memory 404 can include program instructions for performing signal processing and/or any of various possible general processing functions. The processing circuitry 402 can be capable of executing the program instructions stored in the memory 404. The memory 404 can also store data generated and/or used during processing performed by the processing circuitry 402.

As shown, the modem 400 can further include interface circuitry, e.g., for communicating with other components of a wireless device (such as STA 106 or AP 104 illustrated in FIGS. 1-3), such as an application processor, radio/transceiver circuitry, and/or any of various other components. Such interfaces can be implemented in any of various ways; for example, as one possibility, the modem 400 can have a direct interface with transceiver circuitry of a wireless device, and can have an additional indirect interface with an application processor and/or other components of the wireless device by way of a system bus. Other configurations are also possible.

In at least some instances, the hardware and software components of the modem 400 can be configured to implement or support implementation of features described herein, such as retrieving buffered downlink data across a roaming transition, among various other possible features. For example, the processing circuitry 402 of the modem 400 can be configured to implement, or support implementation of, part or all of the methods described herein, e.g., by executing program instructions stored on memory (e.g., non-transitory computer-readable memory medium) 404 and/or using dedicated hardware components.

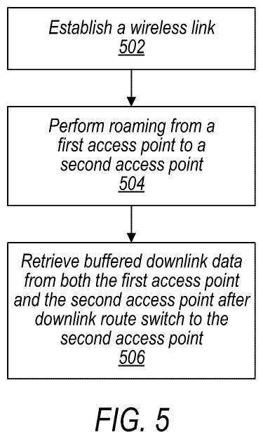

### FIG. 5—Flowchart for Retrieving Buffered Downlink Data Across a Roaming Transition

FIG. 5 is a flowchart diagram illustrating a method for supporting retrieval of downlink data from a previous serving access point after roaming, potentially including concurrent downlink operation with multiple access point devices, in a WLAN system, according to some embodiments. In various embodiments, some of the elements of the methods shown can be performed concurrently, in a different order than shown, can be substituted for by one or more other method elements, or can be omitted. Additional method elements can also be performed as desired.

Aspects of the method of FIG. 5 can be implemented by a wireless device, such as the AP 104 or STA 106 illustrated in and described with respect to FIGS. 1-4, or more generally in conjunction with any of the computer circuitry, systems, devices, elements, or components shown in the Figures, among others, as desired. For example, a processor (such as baseband processor 400 illustrated in and described with respect to FIG. 4) and/or other hardware of such a device can be configured to cause the device to perform any combination of the illustrated method elements and/or other method elements.

Note that while at least some elements of the method of FIG. 5 are described in a manner relating to the use of communication techniques and/or features associated with IEEE 802.11 specification documents, such description is not intended to be limiting to the disclosure, and aspects of the method of FIG. 5 can be used in any suitable wireless communication system, as desired. As shown, the method can operate as follows.

At least two wireless devices may establish a wireless association (502). The wireless association may be established using Wi-Fi, wireless communication techniques that are based at least in part on Wi-Fi, and/or any of various other wireless communication technologies, according to various embodiments. For example, an access point (AP) wireless device may provide beacon transmissions including information for associating with the AP wireless device, and one or more other wireless devices (e.g., non-AP wireless devices) may request to associate with the AP wireless device using the information provided in the beacon transmissions, as one possibility. Variations and/or other techniques for establishing an association are also possible.

The AP wireless device may provide wireless local area network functionality to associated wireless devices, at least according to some embodiments. As part of the wireless local area network functionality, it may be possible for wireless devices to contend for medium access and perform wireless transmissions on one or more wireless communication channels (each of which could possibly include multiple sub-channels) according to general provisions of the wireless communication technology in use by the wireless local area network (e.g., Wi-Fi, as one possibility) and/or network specific parameters configured by the AP wireless device.

The AP wireless device may perform data communication with another wireless device with which it has formed an association. At least according to some embodiments, initiating a data communication can include contending for medium access (e.g., to avoid collisions and potential interference), and, once medium access is obtained, transmitting a physical layer (PHY) protocol data unit (PPDU) (which may also be referred to as a downlink frame) to the destination wireless device. The downlink frame may include physical layer signaling (e.g., including a preamble for frame detection, timing and frequency synchronization, channel estimation, etc., and header information indicating packet configuration, format, data rates, channel occupation time, and/or other control information) and data (which may in turn include one or more higher layer packets, such as media access control (MAC) protocol data units (MPDUs).

A non-AP wireless device that is associated to an AP wireless device can perform roaming to another AP wireless device (504). The roaming may be performed from an “origin” or “serving” AP wireless device (which may also be referred to herein as a “first” AP wireless device, for convenience) to a “target” or “roaming” AP wireless device (which may also be referred to herein as a “second” AP wireless device, for convenience). In some embodiments, the roaming can include the non-AP wireless device providing a roaming initiation indication (e.g., including a roaming announcement indication (RAI) frame, as one possibility) to the first AP wireless device, based on which the first AP wireless device can initiate a network route switch for the non-AP wireless device, such that network traffic for the non-AP wireless device will subsequently be provided to the second AP wireless device. The first AP wireless device can also provide context transfer information for the non-AP wireless device to the second AP wireless device, e.g., to support the roaming transition. Once the network route switch has been initiated and the context transfer has been accomplished, the first AP wireless device can provide an indication that the roaming is ready (e.g., including a roaming announcement response (RAR) frame, as one possibility).

After the roaming, network downlink packets for the non-AP wireless device can be routed to the second AP wireless device, and provided therefrom to the non-AP wireless device. However, there can also be a period of time during and/or after the roaming in which the first AP wireless device has buffered (and possibly continues to receive from the network) downlink packets for the non-AP wireless device, such that there may be buffered downlink packets at the first AP wireless device for the non-AP wireless device to retrieve at the same time that there are buffered downlink packets at the second AP wireless device for the non-AP wireless device to retrieve.

Accordingly, the non-AP wireless device can retrieve buffered downlink data from both the first AP wireless device and the second AP wireless device after the downlink route switch to the second access point (506), at least according to some embodiments.

There can be multiple possible approaches to handling such buffered downlink data retrieval, according to various embodiments. One possible approach can include retrieving the buffered downlink data fully sequentially, such that all buffered downlink data is retrieved from the first AP wireless device before the non-AP wireless device begins receiving downlink data from the second AP wireless device.

In such an approach, the non-AP wireless device can indicate to the second AP wireless device to hold downlink data for the non-AP wireless device while the non-AP wireless device is finishing retrieving the downlink data buffered at the first AP wireless device. For example, as one possibility, the non-AP wireless device can indicate to the second AP wireless device that is in a power save (PS) mode to prevent the second AP wireless device from transmitting downlink data to the non-AP wireless device. The PS mode may also be implied in the roaming protocol, with no need for explicit indication to the second AP.

The non-AP wireless device can also make use of ‘More Data’ signaling (and/or any other desired signaling) from the first AP wireless device to determine whether any additional downlink data is forthcoming from the first AP wireless device. For example, the first AP wireless device could set a ‘More Data’ flag with each transmission of buffered downlink data for the non-AP wireless device to indicate if there is more buffered downlink data available at the first AP wireless device for the non-AP wireless device (e.g., with a flag value of ‘1,’ as one possibility) or if there is no more such data for the non-AP wireless device (e.g., with a flag value of ‘0,’ as one possibility). Additionally, or alternatively, this empty buffer indication from the first AP may be a standalone frame. Additionally, or alternatively, the non-AP wireless device could use an internal timeout mechanism or check whether a backoff calculation criteria is met to determine whether any additional downlink data is forthcoming from the first AP wireless device. For example, if no data from the first AP wireless device is received by the non-AP wireless device within a configured time window, the non-AP wireless device can determine that no additional downlink data is forthcoming from the first AP wireless device, at least as one possibility. Additionally, or alternatively, the non-AP wireless device could request a buffer status report from the first AP wireless device in order to anticipate the size of data that it needs to receive from the first AP wireless device. Additionally, or alternatively, the buffer status report may automatically be transmitted to the non-AP wireless device at various times during the roam procedure.

According to this fully sequential approach, once the non-AP wireless device has determined that no additional downlink data is forthcoming from the first AP wireless device, or that receiving such data is no longer viable or desirable, the non-AP wireless device can indicate to the second AP wireless device to start providing downlink data to the non-AP wireless device. For example, as one possibility, the non-AP wireless device can indicate to the second wireless device that it is no longer in PS mode, which may trigger the second AP wireless device to begin providing buffered downlink data to the non-AP wireless device.

Another possible approach can include retrieving the buffered downlink data sequentially on a per-traffic identifier (TID) basis, such that all buffered downlink data for a given TID is retrieved from the first AP wireless device before the non-AP wireless device begins receiving downlink data for that particular TID from the second AP wireless device. In this approach, the non-AP wireless device can potentially receive downlink data from the first AP wireless device and the second AP wireless device concurrently. For example, if the non-AP wireless device finishes retrieving downlink data for a first TID from the first AP wireless device before finishing retrieving downlink data for a second TID from the first AP wireless device, it could be possible for the non-AP wireless device to receive at least some downlink data for the first TID from the second AP wireless device before at least some downlink data for the second TID is received from the first AP wireless device, at least in some embodiments.

In this approach, the non-AP wireless device can similarly indicate to the second AP wireless device to hold downlink data for a set of TIDs for the non-AP wireless device while the non-AP wireless device is finishing retrieving the downlink data buffered at the first AP wireless device for those TIDs.

The non-AP wireless device can make use of signaling from the first AP wireless device configured to indicate when a TID buffer is empty for the first AP wireless device to determine whether any additional downlink data is forthcoming for a given TID from the first AP wireless device, at least according to some embodiments. Additionally, or alternatively, the non-AP wireless device could use an internal timeout mechanism or check whether a backoff calculation criteria is met, on a per TID basis, to determine whether any additional downlink data for a given TID is forthcoming from the first AP wireless device. For example, if no data from the first AP wireless device is received for a given TID by the non-AP wireless device within a configured time window, the non-AP wireless device can determine that no additional downlink data for that TID is forthcoming from the first AP wireless device, at least as one possibility. Note that the configured time window(s) could differ for different TIDs, if desired.

According to this sequential per-TID approach, once the non-AP wireless device has determined that no additional downlink data is forthcoming from the first AP wireless device for a given TID, the non-AP wireless device can indicate to the second AP wireless device to start providing downlink data for that TID to the non-AP wireless device. For example, as one possibility, the non-AP wireless device can indicate to the second wireless device that it is no longer in PS mode, and/or use TID-to-link mapping signaling used to signal which TID(s) can be provided by the second AP wireless device, which may trigger the second AP wireless device to begin providing buffered downlink data for that TID to the non-AP wireless device. As the non- AP wireless device determines that no additional downlink data is forthcoming from the first AP wireless device for additional TIDs, the non-AP wireless device can indicate to the second AP wireless device to start providing downlink data for those TIDs to the non-AP wireless device, for example by modifying the TID-to-link mapping to also map those additional TIDs to the link between the non-AP wireless device and the second AP wireless device.

Still another possible approach can include supporting fully concurrent retrieval of buffered downlink data from the first AP wireless device and the second AP wireless device. In this approach, the non-AP wireless device can potentially receive downlink data from the first AP wireless device and the second AP wireless device concurrently. This can be achieved straightforwardly if the non-AP wireless device is capable of handling two sequence number (SN) spaces and two block acknowledgement (BA) sessions per TID, e.g., such that the second AP wireless device can start SN values from 0 and the non-AP wireless device can perform receive reorder buffering independently for downlink data received from the first AP wireless device and the second AP wireless device, although providing support for such independent receive reorder buffering may have its own implementation complexity cost, at least according to some embodiments. This can also be achieved using a single SN space across the roaming transition with methods for coordinating SN synchronization between the first AP wireless device and the second AP wireless device, e.g., to ensure that they operate on the same bitmap window, to avoid new packets being incorrectly identified as duplicate packets, to avoid packet number reuse, etc.

To coordinate SN synchronization, the first AP wireless device can provide an indication of its last expected PN and SN (e.g., per TID) to both the second AP wireless device (e.g., with context transfer information) and the non-AP wireless device (e.g., with roaming ready indication). Additionally, or alternatively, the first AP wireless device can provide an indication of starting PN and SN (e.g., per TID) for the second AP wireless device to both the second AP wireless device and the non-AP wireless device. In some embodiments, the second AP wireless device and/or the non-AP wireless device can determine the last expected PN and SN for the first AP wireless device from the starting PN and SN for the second AP wireless device (e.g., by adding 1 to these numbers) and/or can determine the starting PN and SN for the second AP wireless device from the last expected PN and SN for the first AP wireless device (e.g., by subtracting 1 from these numbers). The first AP can also provide BA window starting sequence number and size information to the second AP wireless device (e.g., with context transfer information). Note that the first AP wireless device can determine the last expected PN and SN for the first AP wireless device and/or the starting PN and SN for the second AP wireless device both based on any remaining buffered downlink data for the non-AP wireless device and also including a gap for possible additional downlink data packets for the non-AP wireless device that might be received by the first AP wireless device after the context transfer information for the non-AP wireless device is provided to the second AP wireless device.

The concurrent downlink data provision from the first AP wireless device and the second wireless device can be limited by the BA window for the non-AP wireless device (e.g., on a per-TID basis). For example, it can be possible that the second AP only sends downlink data with SN values within the current BA window. As it receives BAs from the non-AP wireless device, the second AP wireless device can move its SSN forward. In some instances, it can be possible for the second AP wireless device to send BA request (BAR) frames to the non-AP wireless device with no window move. It can also be possible for the non-AP wireless device to send unsolicited BAs to move forward the BA window for the second AP wireless device. These frames can potentially help maintain the synchronization between the first AP wireless device, the second AP wireless device, and the non-AP wireless device across the roaming transition.

Yet another possible approach can include transferring buffered downlink data from the first AP wireless device to the second AP wireless device based on the non-AP wireless device roaming from the first AP wireless device to the second AP wireless device. In this approach, it can be the case that the amount of data that cannot be transferred to the second AP wireless device (e.g., an amount remaining in a hardware buffer, as one possibility) may be relatively small. In this case, it can be unlikely that the non-AP wireless device would need or benefit significantly from supporting concurrent reception of downlink data from the first AP wireless device and the second AP wireless device. For example, in at least some scenarios, it can be common for the non-transferable buffered data to already be sent by the time the roaming ready indication is sent. SSN continuity can also be supported in this case, if desired. For example, the first AP wireless device can provide starting SN and PN values to the second AP wireless device based on its current buffer. This can be a precise indication (e.g., with no gap left between the last buffered downlink frame and the indicated starting SN and PN values) since all future downlink frames can be transferred to the second AP wireless device, at least in some embodiments. At least in some embodiments, the downlink data transfer from the first AP wireless device to the second AP wireless device can occur after completion of the context transfer, e.g., in a separate frame (or multiple separate frames), for example to avoid extending the length of the context transfer. The second AP wireless device can then provide the transferred downlink data to the non-AP wireless device.

Thus, according to the method of FIG. 5, it can be possible to a non-AP wireless device to retrieve downlink data buffered at an origin AP wireless device during and/or after roaming to a target AP wireless device, using any of multiple possible approaches. The various approaches can provide different options for levels of potential implementation complexity as well as throughput and latency benefits, at least according to some embodiments.

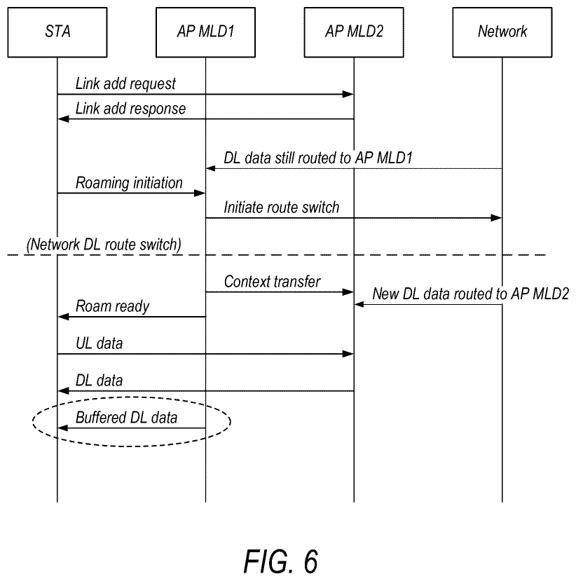

### FIGS. 6-18 and Additional Information

FIGS. 6-18 illustrate further aspects that might be used in conjunction with the method of FIG. 5 if desired. It should be noted, however, that the exemplary details illustrated in and described with respect to FIGS. 6-18 are not intended to be limiting to the disclosure as a whole: numerous variations and alternatives to the details provided herein below are possible and should be considered within the scope of the disclosure.

When a STA performs roaming between access points, the data path may switch from an “origin” or “serving” access point to a “target” or “roaming” access point, such that the STA sends new uplink frames to and receives new downlink frames from the target access point after the data path switch. It can be possible that some downlink frames remain at the origin access point even after such a data path switch. The STA can be allowed to retrieve these buffered downlink frames from the origin AP after the route switch.

FIG. 6 is a signal flow diagram illustrating example aspects of one possible approach to such operation, according to some embodiments. As shown, a STA may add a link with AP MLD2 while a link with AP MLD1 is already established, and while downlink data is still routed to AP MLD1. The STA may initiate roaming, which may cause the AP MLD1 to initiate a route switch, and may provide context transfer to the target AP MLD2. As shown, new downlink data for the STA may then be routed to AP MLD2, and new uplink data from the STA may be provided to AP MLD2, but also buffered downlink data can continue to be received by the STA from AP MLD1 after the data path switch.

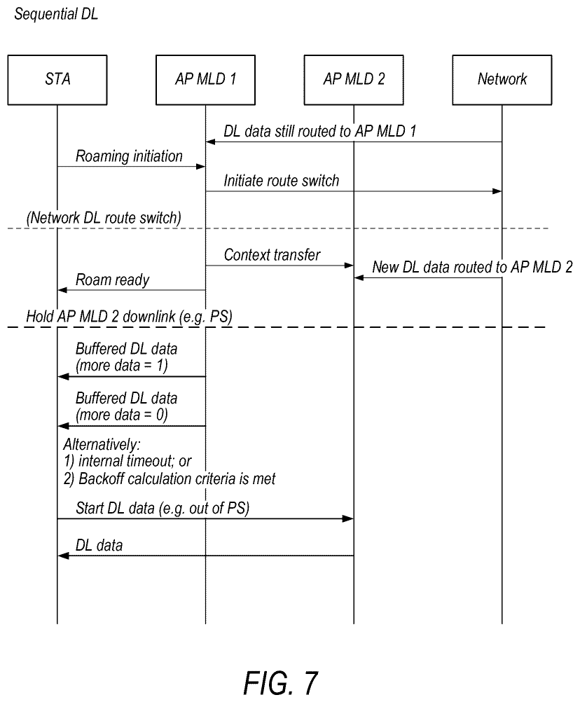

There may be multiple options for how to accomplish such retrieval of downlink data from an origin AP after roaming to a target AP. FIG. 7 illustrates aspects of one possible approach to such retrieval, which can also be referred to as fully sequential, according to some embodiments. In this approach, the STA completes retrieving all AP MLD 1 buffered downlink data and then starts receiving new data from AP MLD 2. As shown, the STA may initiate roaming and wait for the signal indicating that the route switch is complete. The STA may hold AP MLD 2 downlink (e.g., by indicating explicitly or implicitly that the STA is in power saving (PS) mode, as one possibility) and continue retrieving downlink data from AP MLD 1 until the downlink buffer at AP MLD 1 for the STA is empty. As one possibility, the buffered downlink data can be provided with an indication of whether more data is available at AP MLD 1 (e.g., a ‘More Data’ flag can be set to ‘1’ if more data is available, or set to ‘0’ if more data is not available). As another possibility, a standalone frame transmitted by AP MLD 1 may signal empty downlink buffer status for the STA. The STA can then signal to the AP MLD 2 that it is ready to retrieve downlink data from the AP MLD 2 (e.g., by indicating that the STA is out of PS, as one possibility). Such an approach may be relatively simple to implement, at least in some embodiments. It can be possible that one block acknowledgement (BA) session active per traffic identifier is used. Sequence numbers (SNs) can start from 0 in AP MLD 2, if desired. The starting packet number (PN) at AP MLD 2 can be pre-determined by AP MLD 1 during context transfer (e.g., in case of shared pairwise transient key (PTK)). This approach may preserve packet order. A single radio device may be able to implement such an approach.

Note that a STA may have multiple options (e.g., in addition or as alternatives to use of a ‘More Data’ flag or a standalone frame) for detecting whether buffered downlink data is available at the origin AP MLD 1. As one possibility, a STA can have an internal timeout configured, such that if no data from AP MLD 1 is received within the configured time period, the STA can switch to receiving from AP MLD 2. As another possibility, a STA can use an enhanced distributed channel access (EDCA) backoff calculation threshold. The backoff can be reduced over a certain number of steps for best effort access category traffic. The STA can switch to receiving from AP MLD 2 when the backoff calculation criteria is met.

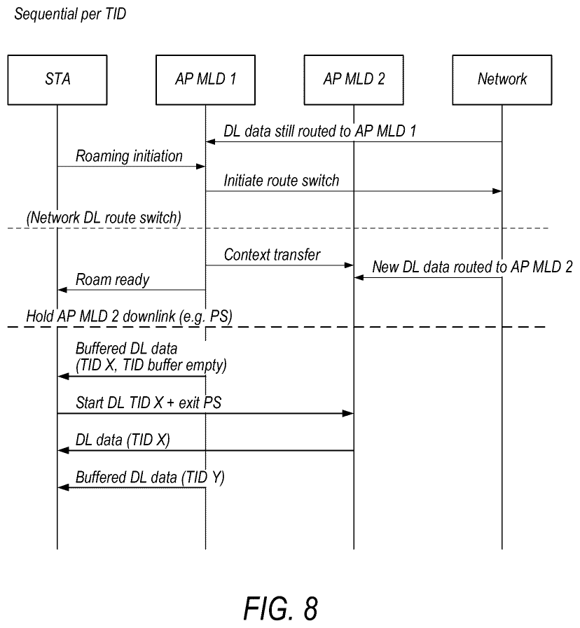

FIG. 8 illustrates aspects of another possible approach to retrieval of downlink data from an origin AP after roaming to a target AP, according to some embodiments. In this approach, which can also be referred to as sequential per TID, a STA completes retrieving AP MLD 1buffered data for a TID and then starts receiving new data from AP MLD 2 for that TID. As shown, the STA may initiate roaming and wait for the signal indicating that the route switch is complete. The STA may continue retrieving downlink data from AP MLD 1 until each TID buffer at AP MLD 1 for the STA is empty. The STA can signal to the AP MLD 2 that it is ready to retrieve downlink data from the AP MLD 2 for a TID once that TID buffer at AP MLD 1 is empty. Such an approach may also be relatively simple to implement, at least in some embodiments. It can be possible that one block acknowledgement (BA) session active per traffic identifier is used. SNs can start from 0 in AP MLD 2, if desired. PN reuse can be avoided by providing a gap during context transfer (e.g., in case of shared PTK). It may be the case that PN order is increasing per AP MLD (e.g., again in case of shared PTK). This approach may preserve packet order. Per-TID buffer status signaling from the origin AP (e.g., AP MLD 1) to the STA and per-TID ready-to-receive signaling from the STA to the target AP (e.g., AP MLD 2) may be used as part of this approach. This approach may be advantageous for MLD operation with mixed low latency and non-low latency traffic, e.g., since it can be possible that non-low latency traffic remaining in the downlink buffer of the origin AP is not lost and also does not add delay to low latency traffic provided on the new data path, at least in some embodiments.

Note that an internal timeout based approach to determining when all buffered downlink frames from the origin AP have been received for a given TID can also be used in this scenario, at least in some embodiments. For example, a STA can configure an internal timeout, and if no data on the same AC or a higher AC is received from the origin AP before the timeout, the STA can determine that all buffered downlink frames for associated TID(s) have been received from the origin AP. Note also that the STA can use TID-to-link mapping signaling to signal the TIDs that it is ready to receive from the old AP and the new AP, at least in some instances.

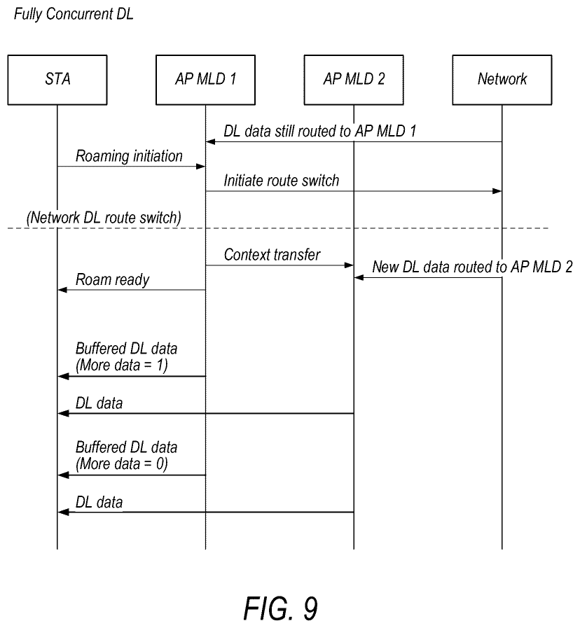

FIG. 9 illustrates aspects of yet another possible approach to retrieval of downlink data from an origin AP after roaming to a target AP, according to some embodiments. In this approach, which can also be referred to as fully concurrent downlink, a STA can continue retrieving AP MLD 1 buffered data while starting to receive new data from AP MLD 2 at the same time and for the same TID. It can be possible that a STA is capable of handling two SN spaces/two BA sessions, in which case SN order/synchronization across the roam is not important. Thus, for simplicity, AP MLD 2 could start SN values from 0, as one possibility. It can also be possible that a STA has a single SN space and/or order matters, in which case it may be useful to provide techniques for coordinating SN synchronization between the two AP MLDs, e.g., to ensure that they operate on the same bitmap window. This approach may also be advantageous for MLD operation with mixed low latency and non-low latency traffic, e.g., since it can be possible that non-low latency traffic remaining in the downlink buffer of the origin AP is not lost and also does not add delay to low latency traffic provided on the new data path, at least in some embodiments. This approach may potentially provide throughput gain per TID during roaming, at least in some embodiments, however it may also be possible that higher complexity is required for out of order packet handling.

Note that for real time data (e.g., audio and video), the packets can contain timing information that can be used to define the playout time of the packet. In these cases, the STA can organize the order based on the payload header information and it may be the case that WLAN MAC layer receive order is not relevant.

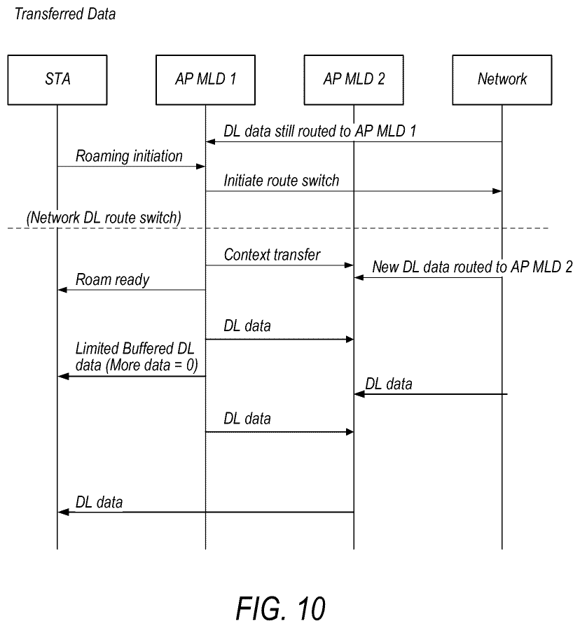

FIG. 10 illustrates aspects of still another possible approach to retrieval of downlink data from an origin AP after roaming to a target AP, according to some embodiments. In this approach, which can also be referred to as transferred data, AP MLD 1 may have a limited amount of data that it cannot transfer (e.g., MPDUs in hardware buffer, possibly), while all other downlink data for the STA is transferred to AP MLD 2. The data transfer can happen after the completion of the context transfer, for example to avoid extending the length of the context transfer and a potential uplink pause (it may be the case that uplink frames are always transmitted to the new AP MLD 2 after the roaming initiation). As the amount of data that cannot be transferred to AP MLD 2 is likely to be small in such an approach, providing support for concurrent downlink may provide little benefit; for example, in some instances, such data might already be provided to the STA by the time the roam ready indication is sent. In this approach, starting sequence number continuity can be supported if desired. In this case, AP MLD 1 can send SN and PN values to AP MLD 2 based on its current buffer (given that all future DL frames will be transferred to AP MLD 2). Thus, in this scenario, SN space collision across the roaming operation may not be a significant concern, at least according to some embodiments.

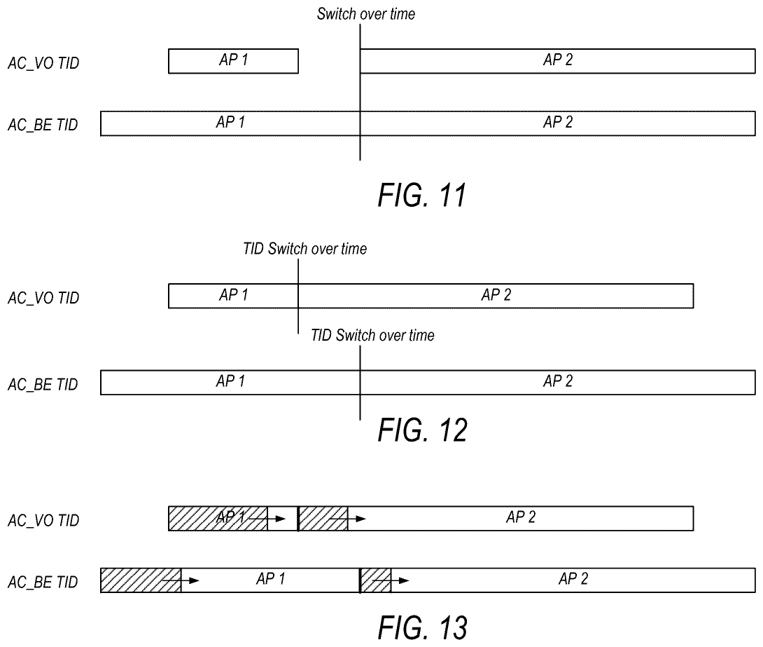

FIGS. 11-13 illustrate a possible comparison between the downlink retrieval options illustrated in and described with respect to FIGS. 7-9 in an example scenario in which a STA has active TIDs in voice (AC_VO) and best effort (AC_BE) access categories. The scenario of FIG. 11 may correspond to a sequential approach in which a STA is roaming from AP 1 to AP 2. As shown, all of the traffic buffered at AP 1 may be retrieved before any traffic buffered at AP 2 is retrieved. The scenario of FIG. 12 may correspond to a sequential per-TID approach in which a STA is roaming from AP 1 to AP 2. As shown, all of the AC_VO traffic buffered at AP 1 is retrieved before any AC_VO traffic buffered at AP 2 is retrieved, and all of the AC_BE traffic buffered at AP 1 is retrieved before any AC_BE traffic buffered at AP 2 is retrieved. Since all of the AC_VO traffic buffered at AP 1 is retrieved before all of the AC_BE traffic buffered at AP 1 is retrieved, the STA can begin retrieving AC_VO traffic buffered at AP 2 while continuing to retrieve AC_BE traffic buffered at AP 1. The scenario of FIG. 13 may correspond to a fully concurrent downlink approach in which a STA is roaming from AP 1 to AP 2.

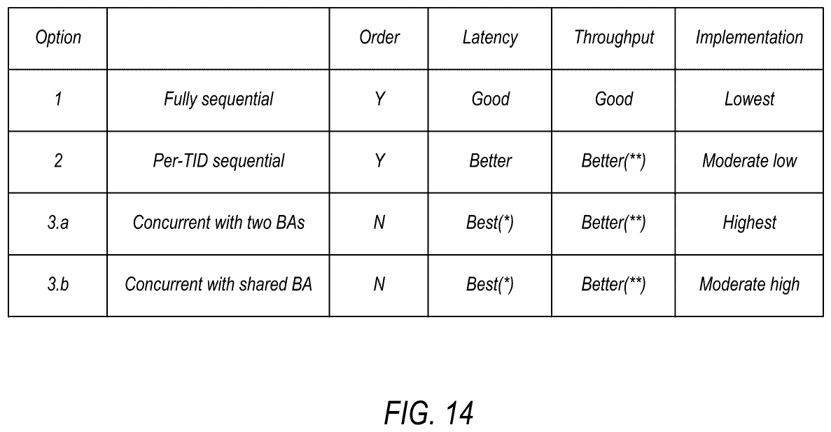

FIG. 14 is a table illustrating potential relative characteristics of fully sequential, per-TID sequential, concurrent with two BA sessions, and concurrent with shared BA session approaches to handling downlink data when roaming from one AP to another AP, at least according to some embodiments. As shown, in some instances, fully sequential and per-TID sequential approaches can provide in order packet delivery, while concurrent approaches can result in out-of-order packet delivery. Latency may be better for a per-TID sequential approach than for a fully sequential approach, and still better for concurrent approaches than for a per-TID sequential approach, in some instances. Throughput may be better for a per-TID sequential approach and for concurrent approaches than for a fully sequential approach, in some instances. Implementation may be easier for a fully sequential approach than for a per-TID sequential approach, which may in turn be easier than for a concurrent with shared BA session approach, which may itself in turn be easier than for a concurrent with two BA sessions approach, in some instances.

At least in some instances, for low latency use cases, traffic order can be important. It can be the case that typical low latency traffic primarily or only is communicated over 5 GHz and 6 GHz frequency bands. In some instances, enhanced multi-link single radio operation may be used between the 5 GHz and 6 GHz frequency bands. Note that while the relative characteristics illustrated in FIG. 14 may be representative in aggregate for some embodiments, it may also be possible that in certain scenarios, different relative performance for the different approaches illustrated can also be possible. For example, it may be possible that EMLSR operation with option 3 could experience poorer latency in some scenarios, e.g., due to a link taking TXOPs for traffic ahead of queue, at least as one possibility.

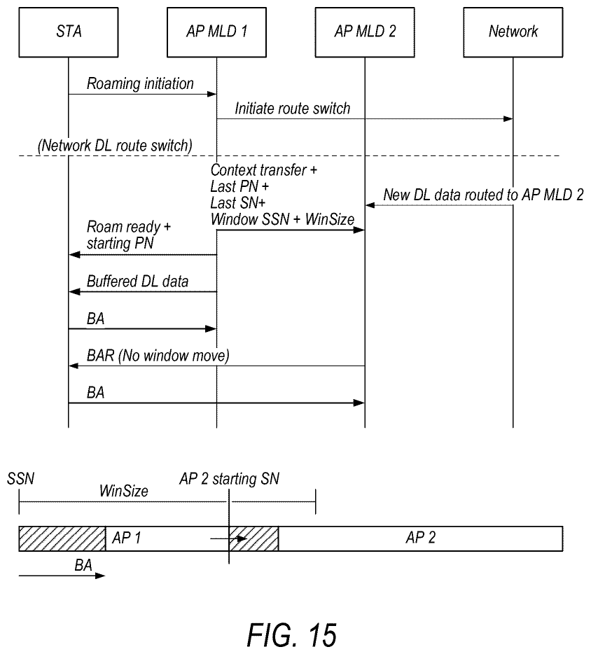

FIG. 15 is a signal flow diagram illustrating further possible details of a concurrent with shared BA session approach to handling downlink data when roaming from one AP to another AP, according to some embodiments. As shown, in the illustrated example scenario, after network route switch, AP MLD 1 sends its last expected PN and SN (SN is per TID) to both AP MLD 2and STA. AP MLD 2 starts SN/PN assignment with these numbers +1 for downlink data for the STA. AP MLD 1 can leave a gap between its current PN/SN and the signaled last PN/SN, e.g., to account for the possibility of more downlink data arriving from the network to AP MLD 1. AP MLD 1 can send downlink data normally and the STA can move the BA window forward accordingly. It may be the case that AP MLD 2 can only send downlink MPDUs to the STA as long as it doesn't violate the end of the STA's current BA window. Thus, initially the AP MLD 2 can only send SNs starting from the given value until window starting sequence number (SSN) +WinSize. As it receives BAs from the STA, AP MLD 2 can move its SSN forward. AP MLD 2can also send BA request (BAR) frames with no window move, at least in some instances. The STA can also send unsolicited BAs to AP MLD 2 to move the window forward.

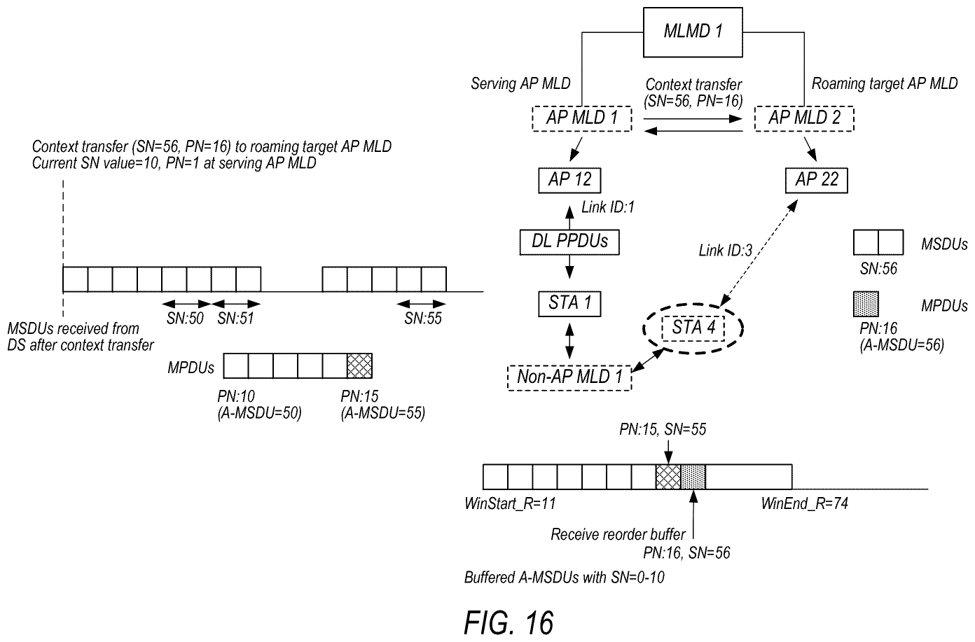

There may be several possible outcomes for the SN and PN space during roaming using this approach. FIG. 16 illustrates example aspects of an outcome in which perfectly non-overlapping SN and PN space is achieved during roaming. This can be a likely outcome if AP MLD 1 provides context transfer information after no more downlink data for the STA is being routed to AP MLD 1 (e.g., if AP MLD 1 knows exactly how many more downlink packets it has buffered for the STA), at least according to some embodiments. It can be the case that agreement is obtained using ADDBA request and response frames established between the non-AP MLD and the serving AP MLD. Within a multi-link multi-device system (MLMD) (e.g., with a logical network entity capable of providing at least some coordination between AP MLDs, in some embodiments), the same agreement can be shared with the roaming AP MLD. AP MLD 1 and AP MLD 2 can thus be concurrently sending downlink physical layer protocol data units (PPDUs) to non-AP MLD 1.

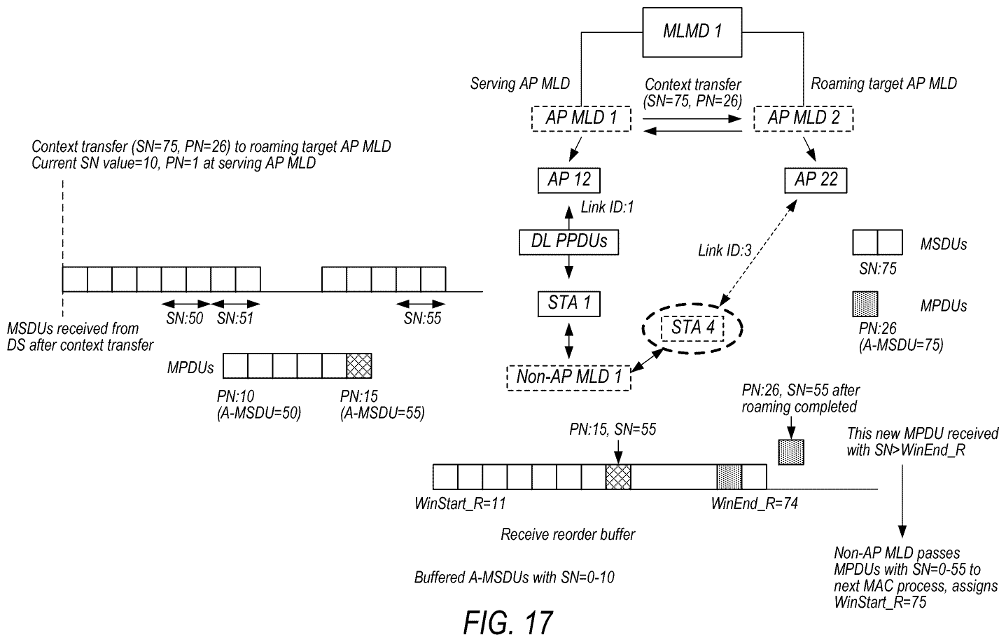

FIG. 17 illustrates example aspects of an outcome in which non-overlapping SN and PN space with a gap is achieved during roaming. This can occur if AP MLD 1 provides, in the context transfer information provided to AP MLD 2, a larger gap than is needed for the amount of downlink data for the STA that is being routed to AP MLD 1 (e.g., if AP MLD 1 overestimates the number of downlink packets for the STA it will receive before network pathing begins routing packets for the STA to AP MLD 2), at least according to some embodiments. In this scenario, it can also be the case that agreement is obtained using ADDBA request and response frames established between the non-AP MLD and the serving AP MLD. Within an MLMD, the same agreement can be shared with the roaming target AP MLD. Note that there may further be multiple sub-cases in this scenario, including if there is a gap between the last SN from AP MLD 1 and the SSN from AP MLD 2 but both fall within the current window, and if there is a gap between the last SN from AP MLD 1 and the SSN from AP MLD 2 and the SSN from AP MLD 2 is outside the WinSize (e.g., SN>WinEnd_R).

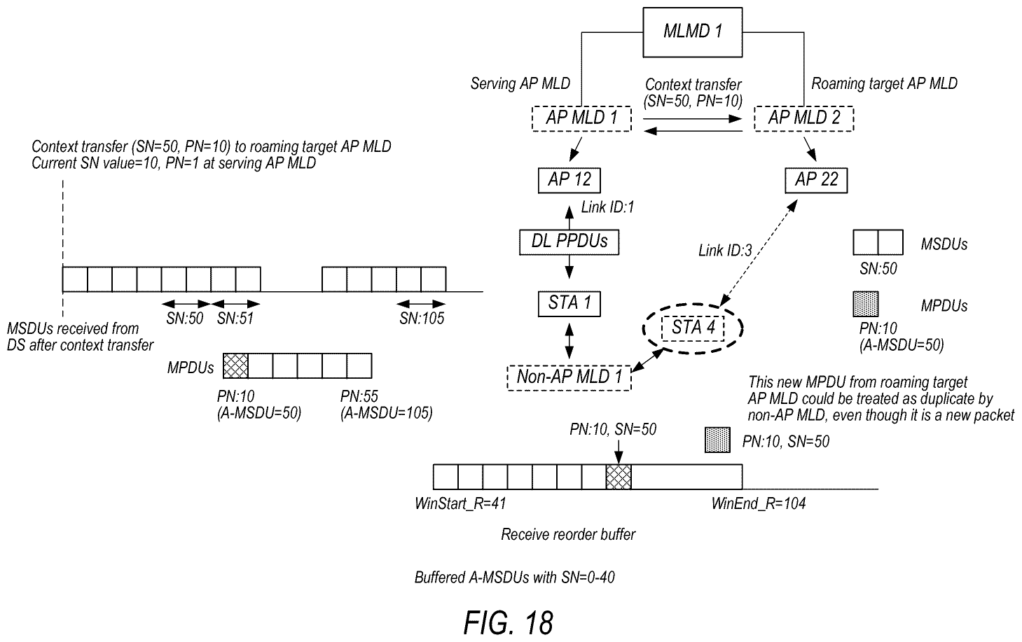

FIG. 18 illustrates example aspects of an outcome in which overlapping SN and PN space occurs roaming. This can occur if AP MLD 1 provides, in the context transfer information provided to AP MLD 2, a smaller gap than is needed for the amount of downlink data for the STA that is being routed to AP MLD 1 (e.g., if AP MLD 1 underestimates the number of downlink packets for the STA it will receive before network pathing begins routing packets for the STA to AP MLD 2), at least according to some embodiments. In this scenario, it can also be the case that agreement is obtained using ADDBA request and response frames established between the non-AP MLD and the serving AP MLD. Within an MLMD, the same agreement can be shared with the roaming AP MLD. AP MLD 1 and AP MLD 2 can be concurrently sending downlink PPDUs to non-AP MLD 1. In this scenario, a new media access control protocol data unit (MPDU) from the roaming target AP MLD could potentially be treated as duplicate by the non-AP MLD, even though it is a new packet.

Receive reorder buffer (RRB) operation updates to avoid potential discarding of new frames as duplicates are possible. Such updates could include, in the roaming phase, providing an ending sequence number (ESN) and PN, and SSN and PN shared with the target AP MLD in the roaming announcement response (RAR) frame from the serving AP MLD, to the non-AP MLD. It can be the case that data path switches before RAR frame transmission and the serving AP MLD should not expect additional packets from the DS. It is possible that it can be assumed that the serving AP MLD has assigned SNs to buffered MSDUs prior to RAR frame transmission. Based on the ESN value in the RAR frame, a non-AP MLD can modify the RRB as follows. If the last packet in RRB=ESN (e.g., no buffered traffic), forward all buffered MSDUs to upper MAC (assuming no gap in RRB). If the last packet in RRB<ESN<WinEnd_R, wait to receive further buffered traffic. If WinEnd_R<ESN<WinEnd_R+WinSize_R, forward all buffered MSDUs to upper MAC and move the window with WinStart_R=WinEnd_R+1. If the SSN of the target AP MLD>ESN and<WinEnd_R, then continue receiving from both AP MLDs. For concurrent reception from the AP MLDs, if the SSN of the target AP MLD<ESN, then continue receiving from both AP MLDs, and do not receive any MPDU from the target AP MLD until the end of reception from the serving AP MLD. If the SSN of the target AP MLD<WinEnd_R and>ESN, then continue receiving from both AP MLDs, and do not receive any MPDU from the target AP MLD until the end of reception from the serving AP MLD. If the SSN of the target AP MLD>WinEnd_R and<ESN, then it can be the case that AP MLD 2 shall not send data to the STA.

Note that in some embodiments, the roaming target AP MLD can start its SSN at 0 and PN at a large value relative to the last PN used for buffered downlink data by the serving AP MLD. The PN value can be assumed to be part of the context transfer message. In this case, the SN need not be part of the context transfer message. As another possibility, after forwarding downlink data from AP MLD 1 to upper MAC, the non-AP MLD can transmit an unsolicited BA frame to the roaming target AP MLD to indicate WinEnd_R. In this case, PN and SN values can be assumed to be part of the context transfer message.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

In addition to the above-described exemplary embodiments, further embodiments of the present disclosure can be realized in any of various forms. For example, some embodiments can be realized as a computer-implemented method, a computer-readable memory medium, or a computer system. Other embodiments can be realized using one or more custom-designed hardware devices such as ASICs. Still other embodiments can be realized using one or more programmable hardware elements such as FPGAs.

In some embodiments, a non-transitory computer-readable memory medium can be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., an AP 104 or a STA 106) can be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device can be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A processor comprising memory configured to cause the processor to perform operations comprising:
initiating roaming from a first AP wireless device to a second AP wireless device;
receiving an indication that roaming from the first AP wireless device to the second AP wireless device is ready;
receiving, from both the first AP wireless device and the second AP wireless device, after roaming from the first AP wireless device to the second AP wireless device is ready, downlink data,
wherein at least a first portion of downlink data received from the second AP wireless device is held at the second AP wireless device until an indication to release at least the first portion of downlink data is received; and
providing, to the second AP wireless device, the indication to release at least the first portion of downlink data.

2. The processor of claim 1, wherein the memory is further configured to cause the processor to perform operations comprising:
providing, to the second AP wireless device, an indication to hold downlink data.

3. The processor of claim 1, wherein the memory is further configured to cause the processor to perform operations comprising:
receiving, from the first AP wireless device, downlink data for a first traffic identifier (TID);
determining that no additional downlink data is forthcoming from the first AP wireless device for the first TID;
providing, to the second AP wireless device, an indication to start providing downlink data for the first TID based at least in part on determining that no additional downlink data is forthcoming from the first AP wireless device for the first TID; and
receiving, from the second AP wireless device, downlink data for the first TID.

4. The processor of claim 3, wherein the memory is further configured to cause the processor to perform operations comprising:
receiving, from the first AP wireless device, downlink data for a second TID;
determining that no additional downlink data is forthcoming from the first AP wireless device for the second TID;
providing, to the second AP wireless device, an indication to start providing downlink data for the second TID based at least in part on determining that no additional downlink data is forthcoming from the first AP wireless device for the second TID; and
receiving, from the second AP wireless device, downlink data for the second TID.

5. The processor of claim 1,
wherein a portion of the downlink data received from the second AP wireless device is received before at least a portion of the downlink data received from the first AP wireless device.

6. The processor of claim 1,
wherein downlink data is received concurrently from both the first AP wireless device and the second AP wireless device after roaming from the first AP wireless device to the second AP wireless device is ready,
wherein separate block acknowledgement sessions are used for downlink data received from the first AP wireless device and the second AP wireless device.

7. The processor of claim 1, wherein the memory is further configured to cause the processor to perform operations comprising:
receiving an indication of a last expected sequence number and packet number for downlink data from the first AP wireless device and an indication of a starting sequence number and packet number for downlink data from the second AP wireless device;
wherein downlink data is received concurrently from both the first AP wireless device and the second AP wireless device after roaming from the first AP wireless device to the second AP wireless device is ready,
wherein the last expected sequence number and packet number for downlink data from the first AP wireless device and the starting sequence number and packet number for downlink data from the second AP wireless device are used to manage a receive reorder buffer during the concurrent reception of downlink data from both the first AP wireless device and the second AP wireless device after roaming from the first AP wireless device to the second AP wireless device is ready.

8. The processor of claim 7, wherein the memory is further configured to cause the processor to perform operations comprising:
receiving, from the second AP wireless device, a block acknowledgement request frame indicating no block acknowledgement window move.

9. The processor of claim 7, wherein the memory is further configured to cause the processor to perform operations comprising:
providing, to the second AP wireless device, an unsolicited a block acknowledgement frame to move a block acknowledgement window forward for the second AP wireless device.

10. A method, comprising:
by a wireless device that is a roaming target access point (AP) wireless device for a non-AP wireless device:
receiving, from a serving AP wireless device for the non-AP wireless device, context transfer information for the non-AP wireless device, wherein the context transfer information includes at least one of:
an indication of a last expected sequence number for each block acknowledgement (BA) session and a last expected packet number for downlink data from the serving AP wireless device to the non-AP wireless device;
an indication of a starting sequence number for each BA session and a starting packet number for downlink data from the roaming target AP wireless device to the non-AP wireless device; or
an indication of BA window starting sequence number and size for the non-AP wireless device.

11. The method of claim 10, wherein the method further comprises:
providing, to the non-AP wireless device, a BA request frame indicating no BA window move.

12. The method of claim 10, wherein the method further comprises:
receiving, from the non-AP wireless device, an unsolicited a BA frame indicating to move a BA window forward for the non-AP wireless device.

13. The method of claim 10, wherein the method further comprises:
providing, to the non-AP wireless device, downlink data starting with the indicated starting sequence number for each BA session and the starting packet number for downlink data from the roaming target AP wireless device to the non-AP wireless device.

14. The method of claim 10, wherein the method further comprises:
receiving, from the serving AP wireless device, downlink data for the non-AP wireless device; and
providing, to the non-AP wireless device, the downlink data.

15. A first access point (AP) wireless device, comprising:
one or more antennas;
one or more radios operably coupled to the one or more antennas; and
a processor operably coupled to the one or more radios;
wherein the first AP wireless device is configured to:
receive, from a non-AP wireless device, an indication to initiate roaming from the first AP wireless device to a second AP wireless device;
provide, to the second AP wireless device, context transfer information for the non-AP wireless device;
provide, to the non-AP wireless device, an indication that roaming from the first AP wireless device to the second AP wireless device is ready; and
provide, to the non-AP wireless device, after roaming from the first AP wireless device to the second AP wireless device is ready, buffered downlink data.

16. The first AP wireless device of claim 15, wherein the first AP wireless device is further configured to:
provide an indication of whether the first AP wireless device has more buffered downlink data for the non-AP wireless device when providing the buffered downlink data to the non-AP wireless device.

17. The first AP wireless device of claim 16,
wherein the indication of whether the first AP wireless device has more buffered downlink data for the non-AP wireless device is provided per traffic identifier (TID).

18. The first AP wireless device of claim 15, wherein the first AP wireless device is further configured to:
provide, to the non-AP wireless device, an indication of at least one of:
a last expected sequence number and packet number for downlink data from the first AP wireless device to the non-AP wireless device; or
a starting sequence number and packet number for downlink data from the second AP to the non-AP wireless device; and
provide, to the second AP wireless device, an indication of a block acknowledgement window starting sequence number and size for the non-AP wireless device and at least one of:
the last expected sequence number and packet number for downlink data from the first AP wireless device to the non-AP wireless device; or
the starting sequence number and packet number for downlink data from the second AP to the non-AP wireless device.

19. The first AP wireless device of claim 18, wherein the first AP wireless device is further configured to:
determine at least one of the last expected sequence number and packet number for downlink data from the first AP wireless device to the non-AP wireless device or the starting sequence number and packet number for downlink data from the second AP to the non-AP wireless device based at least in part on a number of downlink data packets for the non-AP wireless device buffered by the first AP wireless device and a gap for possible additional downlink data packets for the non-AP wireless device received by the first AP wireless device after the context transfer information for the non-AP wireless device is provided to the second AP wireless device.

20. The first AP wireless device of claim 15, wherein the first AP wireless device is further configured to:
provide, to the second AP wireless device, based at least in part on the non-AP wireless device roaming from the first AP wireless device to the second AP wireless device, buffered downlink data for the non-AP wireless device.
